(19) United States
(12) Patent Application Publication
(10) Pub. No.: US 2015/0197679 A1
(43) Pub. Date: Jul. 16, 2015

(54) THERMOSTATIC PACKAGING AND METHODS FOR THEIR PREPARATION AND USE

(71) Applicant: EMPIRE TECHNOLOGY DEVELOPMENT LLC, Wilmington, DE (US)

(72) Inventor: Yansong GU, Bellevue, WA (US)

(21) Appl. No.: 14/594,253

(22) Filed: Jan. 12, 2015

Related U.S. Application Data
(60) Provisional application No. 61/925,804, filed on Jan. 10, 2014.

(51) Int. Cl. C09K 5/06; C08F 251/02; B01J 20/26; C08F 257/02

(52) U.S. Cl. CPC C09K 5/066; C09K 5/063; C08F 257/02; C08F 251/02; B01J 20/264

(57) ABSTRACT

Thermostatic packaging materials, and methods for making and using the materials are disclosed. The materials may include phase change materials that are covalently bound with the packaging material to avoid any leaching of liquefied phase change materials. The phase change materials may be copolymerized with hydrogels to provide an absorbent thermostatic material.

### CROSS REFERENCE TO RELATED APPLICATION

This application claims the benefit under 35 U.S.C. 119(e) of U.S. Provisional Application No. 61/925,804, filed Jan. 10, 2014 entitled “Thermostatic Packaging And Methods For Their Preparation And Use,” the disclosure of which is incorporated by reference in its entirety.

### BACKGROUND

Temperature variations during transport of products, especially food, are a significant factor that may lead to the deterioration of the product. For example, high temperatures may lead to acceleration of food spoilage. One type of packaging for temperature control may include phase change materials (PCMs). A PCM is a material with a high heat of fusion which, upon melting or solidifying at a certain temperature, is capable of storing and releasing large amounts of energy. When PCM is used in food packaging materials, it may leak when PCM liquefies at a higher temperature. Further, PCM in food packaging materials may also result in bulky packaging.

### SUMMARY

Packaging materials that have thermostatic properties may include PCMs that are covalently bound with the packaging material. The resulting packaging materials will have thermostatic ability for maintaining a temperature of the packaged contents while avoiding PCM leaching problems. The PCMs may be copolymerized with additional monomers to alter the functionality of the PCMs. In an embodiment, the additional monomers may be hydrogels, and the polymer may, in addition to maintaining the temperature of the contents, also function as an absorbent material. For example, the absorbent material can absorb moisture from areas adjacent to the contents.

In an embodiment, a thermostatic packaging may include a packaging material and at least one phase change material covalently bonded with the packaging material.

In an embodiment, an absorbent packaging insert may include at least one thermostatic hydrogel copolymer.

In an embodiment, a method for packaging an item may include providing at least one thermostatic hydrogel copolymer adjacent to the item to maintain a temperature in an area adjacent to the item, to absorb moisture from the area adjacent to the item, or both.

In an embodiment, a method for producing a thermostatic packaging material may include covalently bonding at least one phase change material with a packaging material.

### BRIEF DESCRIPTION OF THE FIGURES

FIG. 1 depicts representative illustrations of co-polymers of phase change materials according to an embodiment.

FIG. 2 depicts a detailed embodiment of a phase change material copolymer according to an embodiment.

FIG. 3 depicts a representative illustration of co-polymers of phase change material and hydrogel according to an embodiment.

FIG. 4 depicts a representative method for producing a polymerizable phase change material according to an embodiment.

FIG. 5 depicts polymerizable fatty acid phase change materials according to an embodiment.

### DETAILED DESCRIPTION

Packagings that include phase change materials (PCMs) provide some control of the temperature within packages made from such materials. However, PCMs provide this temperature control at a melting/solidification temperature at which the PCM changes between solid and liquid states. Thus, a solid PCM will melt and become a liquid upon heating to its melt temperature and a liquid PCM will solidify and become a solid upon cooling to below its melt temperature. Solid materials have a definite shape and structure and may be formed into shaped articles. As such, the PCM in its solid state may not require any additional containment during use. In liquid form however, the shape and structure are no longer definite and the PCM in its liquid state will disperse unless contained by a barrier material. Therefore, to use PCMs for thermal buffering, consideration must be given to containment of the PCMs upon melting or liquification.

One manner of containment of the liquid phase may include polymerizing the PCMs with the packaging materials. Polymerizable PCMs may be used to graft coat packaging materials, such as paper based products or polymer based products. Additionally, polymerizable PCMs may be copolymerized with packaging polymers. In the resulting packaging material, PCM moieties may appear as islands of “PCM blocks” within the packaging material. Since the PCM blocks are covalently bound to other material, PCM leaching may be eliminated or contained. The packaging materials may be used for containing food or drink products therein, as well as other types of products, that may require temperature control, for example, during transport. Food packaging materials including PCMs may allow the food/beverage content to stay hot or cold for a longer time than traditional packages. In addition, when a consumer is holding a hot beverage or food, for example, in a paper cup or box, a PCM coated cup or box may not heat up as quickly to the surface outside, allowing the consumer to hold and use the cup or box without an additional thermal sleeve or wrap, which could lead to savings for packaging material costs.

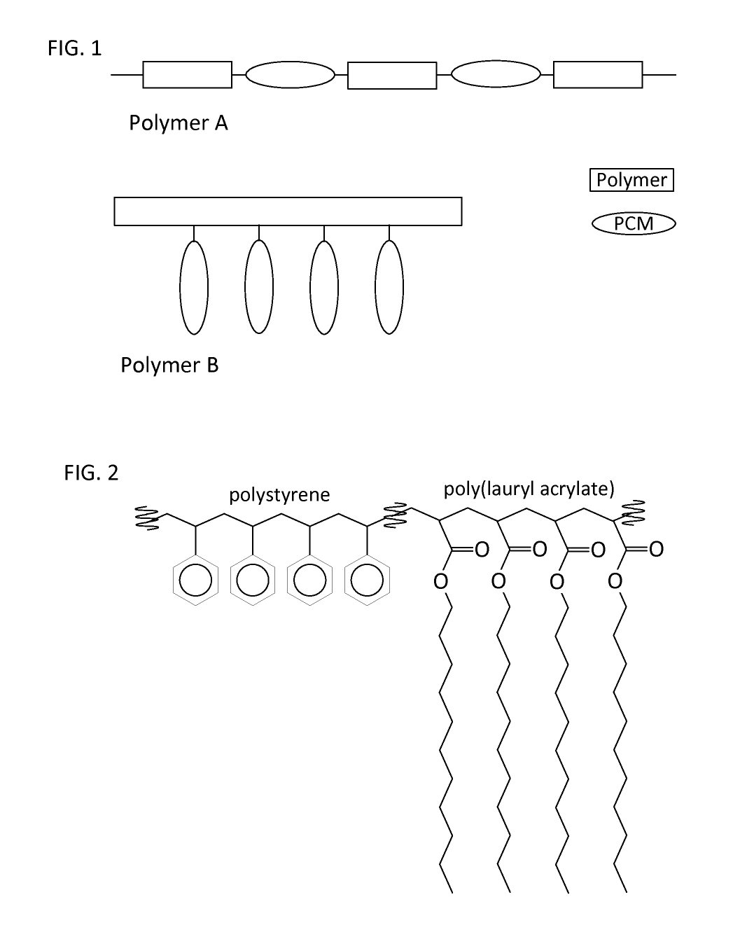

In some embodiments, a thermostatic packaging may include a packaging material and at least one PCM covalently bonded with the packaging material. The phase change material that is covalently bonded with the packaging material can be derived from polymerizable phase change material. In various embodiments, the PCMs may be applied as a coating onto the packaging material, or may be constituted as a component within the packaging material. In some embodiments, the PCM may include at least one block of polymerized PCM, and the at least one block of polymerized PCM may be grafted onto the packaging material. In some embodiments, the packaging material may include at least one packaging polymer. As represented in FIG. 1, polymers for making the thermostatic packaging may include either block copolymers of PCM blocks copolymerized in a linear arrangement with blocks of packaging polymer (polymer A), or may include PCM blocks grafted as side chains onto a packaging polymer (polymer B). The blocks of PCM, blocks of packaging polymer, or both, may include a wide number of polymerized monomers, such as about 50 to about 200 polymerized monomers. As examples, the number of polymerized monomers in the PCM blocks may be about 50, about 60, about 70, about 80, about 90, about 100, about 110, about 120, about 130, about 140, about 150, about 160, about 170, about 180, about 190, about 200, or any number between any of the listed numbers.

Some examples of packaging polymers usable for packaging materials include, but are not limited to, cellulose, polyethylene (PE), polypropylene (PP), poly(ethylene-vinyl acetate) (EVA), polystyrene (PS), polyvinyl chloride (PVC), ionomers (I), polyethylene terephthalate (PET), polyvinyl acetate (PVAc), polycarbonates (PC), polyamides (PA), polyvinyl alcohols (PVOH), polyvinylidene chloride (PVDC), polyacrylates, polyurethane, proteins, peptides, silk, lignocellulose, polyimides, epoxy resins, and any combination thereof. In one embodiment, the packaging material may include paper.

Some examples of polymerizable PCMs include PCM monomers having a polymerizable moiety. Some examples of polymerizable moieties include, but are not limited to, acrylates, methacrylates, epoxies, vinyls, or any combination thereof. Some examples of acrylates and methacrylates include, but are not limited to, C₄ to C₅₀ alkyl acrylate, C₄ to C₅₀ alkyl methacrylate, or any combination thereof, and may include caprylic acrylate, caprylic methacrylate, capric acrylate, capric methacrylate, myristic acrylate, myristic methacrylate, palmitic acrylate, palmitic methacrylate, n-tetradecane acrylate, n-tetradecane methacrylate, n-pentadecanyl acrylate, n-pentadecanyl methacrylate, n-hexadecanyl acrylate, n-hexadecanyl methacrylate, h-heptadecanyl acrylate, h-heptadecanyl methacrylate, n-octadecanyl acrylate, n-octadecanyl methacrylate, n-eicosanyl acrylate, n-eicosanyl methacrylate, n-triacontanyl acrylate, n-triacontanyl methacrylate, n-tetracontanyl acrylate, n-tetracontanyl methacrylate, h-pentacontanyl acrylate, and h-pentacontanyl methacrylate. In some examples, the polymerizable PCM may include C₆ to C₅₀ alkyl acrylate, C₆ to C₅₀ alkyl methacrylate, or any combination thereof.

In some embodiments, the packaging material may include cellulose, polyethylene, polypropylene, poly(ethylene-vinyl acetate), polystyrene, polyvinyl chloride, ionomer, polyethylene terephthalate, polyvinyl acetate, polycarbonates, polyamide, polyvinyl alcohol, polyvinylidene chloride, polyacrylate, polyurethane, protein, peptide, silk, lignocellulose, polyimide, epoxy resin or any combination thereof, and the polymerizable PCM may include C₆ to C₅₀ alkyl acrylate, C₆ to C₅₀ alkyl methacrylate, or any combination thereof.

In an embodiment, a copolymer of PCM and packaging polymer may include a copolymer of lauryl acrylate and styrene as represented in FIG. 2B. In an embodiment, a poly(lauryl acrylate)-polystyrene copolymer may be produced via emulsion polymerization or free-radical copolymerization. In another embodiment, lauryl acrylate may be graft copolymerized with polyamide (nylon) or casein (a ‘green’ packaging material) to provide a poly(lauryl acrylate) grafted-polyamide copolymer or poly(lauryl acrylate) grafted-casein copolymer. In an embodiment, the PCM blocks may be grafted onto the casein, a nylon film, or nylon fibers by graft polymerization reactions. In an embodiment, the packaging material may include nylon or casein, and the polymerizable PCM may include dodecyl acrylate grafted to the nylon or casein. In another embodiment, the PCM is poly(dodecyl acrylate), and the packaging material includes a block copolymer of polystyrene and poly(dodecyl acrylate).

The thermal buffering effect of the thermostatic material may be dependent on the melting temperature of the PCM. For example, since poly(laurel acrylate) has a melting temperature of about −5 to about 15° C., a lauryl acrylate-styrene copolymer or a laurel acrylate-polyamide copolymer may have a thermal buffering effect at temperatures of about −10 to about 25° C.

In some embodiments, the packaging material may include a copolymer of monomers of the PCM and at least one additional monomer. The packaging material may include a block copolymer, for example, block copolymers formed from the monomers of the PCM. The monomers of the PCM may be as described above, and may include at least one polymerizable moiety, for example, the polymerizable moieties as described above. The at least one additional monomer may, for example, include the packaging polymers as described above.

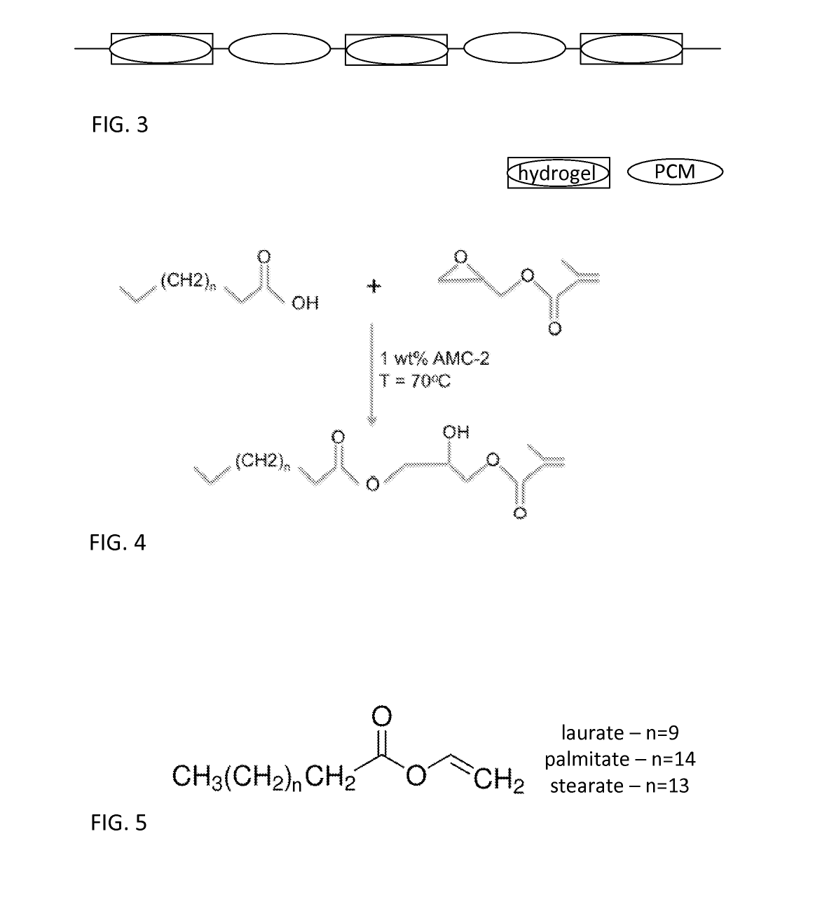

The at least one additional monomer may include a hydrogel. In an embodiment, the phase change material may be copolymerized with a hydrogel. PCM-hydrogel materials may include polymerized monomers of phase changing moieties and hydrogel moieties. In an embodiment, the packaging material may include a block copolymer of polymerized monomers of the PCM and polymerized monomers of the hydrogel. As represented in FIG. 3, the PCM moieties and hydrogel moieties may be polymerized as block copolymers. The PCM-hydrogel block copolymer may include a wide number of polymerized monomers, such as about 50 to about 200 polymerized monomers, that is, polymerized monomers of the PCM and polymerized monomers of the hydrogel. As examples, the number of polymerized monomers in the PCM-hydrogel block copolymer may be about 50, about 60, about 70, about 80, about 90, about 100, about 110, about 120, about 130, about 140, about 150, about 160, about 170, about 180, about 190, about 200, or any number between any of the listed numbers.

In embodiments, the hydrogel blocks may include, but are not limited to, polymerized monomers of acrylic acid, C₂-C₅₀ alkyl acrylate, C₂-C₅₀ alkyl methacrylate, C₂-C₅₀ alkyl-acrylamide, hydrophilic urethane, or any combination thereof. Some examples of polymerizable monomers of hydrogel may include, but are not limited to acrylic acid, C₂-C₅₀ alkyl acrylate, C₂-C₅₀ alkyl methacrylate, C₂-C₅₀ alkyl-acrylamide, hydrophilic urethanes, or any combination thereof.

Hydrogels may be prepared by, for example, crosslinking low molecular weight polymers or oligomers. One example of a cross-linking reaction may include the cross-linking of 1,5-hydroxyl poly(ethylene glycol) and a di-isocyanate. In the presence of a triol as a cross-linker reagent, the reaction may lead to the formation of cross-linked hydrophilic polyurethanes. Alternatively, the conversion of the hydroxyl end groups of poly(ethylene glycol) into (meth)acrylate may be possible, such that it can be cross-linked via radical polymerization.

In some embodiments, the PCM blocks may include polymerized monomers of phase change materials that have a polymerizable moiety. The polymerizable moieties may include, but are not limited to acrylate, methacrylate, epoxy, vinyl, or any combination thereof. Some examples of polymerizable monomers of phase change materials may include, but are not limited to C₄ to C₅₀ methacrylic fatty acids, C₄ to C₅₀ acrylic fatty acids, C₄ to C₅₀ vinyl fatty acids, or any combination thereof. Some examples of polymerizable monomers of phase change materials include, but are not limited to C₆ to C₅₀ methacrylic fatty acid, C₆ to C₅₀ acrylic fatty acid, C₆ to C₅₀ vinyl fatty acid, or any combination thereof.

In some embodiments, the monomers of the phase change material may include fatty acid monomers, and the monomers of the hydrogel may include at least one of acrylates and methacrylates. Saturated fatty acid monomers may include fatty acids having a polymerizable moiety. Examples of fatty acid monomers may include, but are not limited to methacrylated fatty acid monomers, and vinyl fatty acid monomers. Methacrylated fatty acid monomers are generally inexpensive, have low volatilities, and may be free-radically polymerized with vinyl esters.

An example of a synthetic route for producing methacrylated fatty acids may include the addition of an epoxide to a carboxylic acid group of a fatty acid. As represented in FIG. 4, a carboxylic acid group may undergo a simple reaction with the addition of the epoxide group of glycidyl methacrylate to form a methacrylated product. Stoichiometric quantities of the reactants may be mixed together and reacted at certain conditions in the presence of a catalyst, for example at about 70° C. for about 2.5 hours using 1 wt % AMC-2 as a catalyst. The produced methacrylated fatty acid may have one terminal polymerizable unsaturated site per molecule, and the fatty acid monomers may act as chain extenders, analogous to styrene. Methacrylated fatty acids may be long hydrocarbon chains typically ranging in length from 20 to 26 atoms, depending on the fatty acid used. Some example fatty acids may include, but are not limited to lauric acid (C₁₂), palmitic acid (C₁₆), and stearic acid (C₁₈). The properties of any polymers produced may be altered as a function of the length of the fatty acid chain.

Examples of vinyl fatty acid monomers are depicted in FIG. 5 and may include, but are not limited to, vinyl laurate, vinyl palmitate, and vinyl stearate. Polymers of these fatty acids may have melting temperatures of about −5° C. to about 70° C. Thermal buffering ranges for the fatty acid polymers may be about −5° C. to about 5° C. for vinyl laurate, about 20° C. to about 30° C. for vinyl palmitate, and about 50° C. to about 70° C. for vinyl stearate.

In an embodiment, a packaging material may include block copolymers of polymerized fatty acid monomers (PCM) and at least one of polymerized acrylates and polymerized methacrylates (hydrogel). Saturated fatty acid monomers and hydrogel monomers may be co-polymerized to form block co-polymers. For example, in the presence of ethyleneglycol bismethacrylate (EGBMA) as cross-linker, fatty acid monomers may be co-polymerized with (2-hydroxyethyl) methacrylate (HEMA) to form PCM-hydrogel polymers.

In an embodiment, PCM-hydrogel polymers may contain about 35 wt % to about 45 wt % fatty acid monomers, and may be prepared by copolymerization of the fatty acid monomers and acrylate monomers. For example, the PCM-hydrogel polymers may contain the fatty acid monomers in an amount of about 35 wt %, about 37 wt %, about 39 wt %, about 41 wt %, about 43 wt %, about 45 wt %, or a percentage between any of these values. The PCM-hydrogel polymer may be cured using a mixture of additives, for example, a mixture of Trigonox® 239A (Akzo Nobel Chemicals, Chicago, Ill.) containing 45% cumene hydroperoxide, and cobalt naphthenate (CoNap). The Trigonox® and CoNap (Aldrich, Milwaukee, Wis.) may be present in the PCM-hydrogel polymer in an amount of about 1.5% to about 0.375% of the total polymer mass, respectively. The mixture may be cured at an appropriate reaction temperature. For example, lauric acid monomer may be cured at room temperature, while stearic acid monomer, which is solid at room temperature, may need to be cured at an elevated temperature.

In an embodiment, atom transfer radical polymerization may be used for the polymerization of alkyl acrylate and fatty acid monomer. Using copper (I) bromide/pentamethyldiethylenetriamine (CuBr/PMDETA) as the catalyst system, polymerization of alkyl acrylate and fatty acid monomer may generate the block copolymers. Well-defined homopolymers of poly(tert-butyl acrylate) (PtBA; with a polydispersity index=1.14) and poly(methyl acrylate) (PMA; with a polydispersity index=1.03) may be synthesized and then used as macroinitiators for the preparation of PtBA-b-pFA (pFA=polymer fatty acid) and PMA-b-pFA diblock copolymers in bulk under conditions such as at a temperature of 50° C. or in toluene at a temperature of 60° C. or 90° C. In toluene, the amount of CuBr/PMDETA relative to the macroinitiator may be important, and at least 1 equivalent of CuBr/PMDETA may be required for complete initiation. Typical block lengths of the diblock copolymers may be about 100 to about 150 repeat units per segment.

Thermostatic hydrogel copolymers as discussed above may be configured as absorbents, such as, for example package inserts for food packages that may contain a food, such as meats, that may have a liquid component that may come out of the food over time. Absorbent packaging inserts may include a layer of PCM-hydrogel absorbent material as fluid absorbing material. Such inserts may be referred to as “soaker pads” or “purge control pads” and may be manufactured in a wide variety of sizes and shapes, for example, rectangular, oblong, trapezoidal, triangular, circular, oval, donut-shaped, cone, rod, hourglass, “T”-shaped, asymmetric, etc.), and may be adapted to any type and shape of product being packaged.

A PCM-hydrogel absorbent material, in addition to containing any liquid PCM that may form, may also be able to absorb liquids, such as food product fluids in food packaging. PCM-hydrogel absorbent materials may be manufactured in the form of synthetic fibers or filaments, either woven or non-woven. Non-woven may refer to a web that has a structure of individual fibers or threads which are interlaid, but not in any regular, repeating pattern. The individual fibers may be secured or attached to each other. PCM-hydrogel materials may be co-woven or blended with other polymer materials used in the food packaging inserts including, for example, polyesters, polyethylene, polypropylene or a polypropylene polyethylene co-polymer.

The PCM-hydrogel absorbent material may be further blended with other absorbent materials, including tissue wraps and tissue laminates, absorbent sponge materials including cellulose sponge, absorbent foams including open cell and closed cell foams, polymeric material including superabsorbent polymers, and other absorbents.

Absorbent inserts may include a single type of absorbent material or a mixture with other absorbent materials, or additives. Various other absorbentmaterials maybe included with the PCM-hydrogel material, such as, for example, superabsorbent polymers that may be able to absorb many times their weight in liquid. Superabsorbents may be any of chemically modified starch and cellulose, polyvinyl alcohol), poly(ethylene) oxide, and cross-linked poly(acrylic acid). Examples include, but not limited to, sodium salts of cross-linked poly(acrylic acid)/polyalcohol and sodium carboxy methyl cellulose cross-linked with a suitable aluminum compound. These polymers are hydrophilic and have a high affinity for water. The polymers are typically dried and milled into granular solids which swell to a gel upon absorbing water.

Other superabsorbent materials include, but are not limited to, superabsorbent composites of superabsorbent polymer granules adhered with one or more binders and/or plasticizers, airlaid materials with superabsorbent, fibrous or foam structures that have been coated or impregnated with a superabsorbent, nonwoven fabric structures such as thermal bond or resin bond that contain superabsorbent particles or fibers, absorbent structures containing superabsorbent material formed and/or cross-linked in-situ, absorbent gelling materials including gelatinized starches, gelatin, dextrose, or any combinations thereof.

In addition to superabsorbent materials, other absorbent materials may include cellulosic materials that may include, but are not limited to, wood pulp (wood fluff), rayon, needle punctured rayon, lyocell (TENCEL®), cotton, rag paper, pulp paper blotter, creped cellulose wadding, chemically stiffened, modified or cross-linked cellulosic fibers including, for example, carboxymethylcellulose (CMC) and salts thereof, hydroxyethylcellulose, methylcellulose, and hydroxypropylmethylcellulose, or any combination thereof. Other absorbent materials may include, but are not limited to, high yield pulp fibers, flax, milkweed, abaca, hemp, cotton or similar materials that are naturally wet resilient, or any wood pulp fibers that are chemically or physically modified, for example, cross-linked or curled, that have the capability to recover after deformation in the wet state, as opposed to non-resilient fibers which remain deformed and do not recover after deformation in the wet state. Wet-resistant bonds are fiber-to-fiber bond sites that are resistant to disruption in the wet state resulting in improved wet tensile strength.

Some examples of additives that may be included with PCM-hydrogel copolymers include, but are not limited to, binder fibers, bactericidal agents, and additives to improve absorbency. Additives which improve absorbance include, but are not limited to, clays (such as attapulgite, montmorillonite (including bentonite clays), hectorite, sericite, kaolin), mineral compositions such as diatomaceous earth, inorganic salts, polymeric flocculating agents, carboxy-methyl-cellulose, starch, dextrose, gelatin, natural gums (such as xanthan, guars, and alginates), inorganic buffers, superabsorbent polymers in the form of in the form of a fiber, powder, flake, particle, or granule, or other form, including carboxy-methyl-cellulose superabsorbent compounds and acrylic superabsorbent (acrylic acid and sodium acrylate copolymer) compounds, and any combination thereof.

Other additives include binder fibers which facilitate binding of the absorbent layer to the top or bottom sheet. Binder fibers include coextruded materials such as polypropylene/polyethylene, polyester/polyethylene, and polyester/polypropylene fibers.

Other additives may also include, or contain anti-bactericidal/anti-microbial agents. Some examples of anti-bactericidal agents include, but are not limited to, broad spectrum antibiotics, for example, tetracycline and its derivatives, such as chlorotetracycline and oxytetracycline, penicillin, sorbic acid, alkyl substituted or alkyl aryl substituted quaternary ammonium compounds including trimethyldodecylammonium chloride, cetyltrimethylammonium bromide and alkyldimethylbenzylammonium chloride, chlorine containing compounds, such as hypochlorites and chloroamines, iodine compounds, such as sodium hypoiodite, phenol and its derivatives, such as pentachlorophenol and orthophenylphenol, dehydroactic acid, peroxygen compounds such as hydrogen peroxide, potassium persulfate, peracetic acid and sodium perborate, and any combination thereof.

An item that may need to be maintained at a temperature or within a specific temperature range may be packaged with at least one thermostatic hydrogel copolymer by providing at least one thermostatic hydrogel copolymer at least adjacent to the item to maintain the temperature in an area adjacent to the item, absorb moisture from the area adjacent to the item, or both. As discussed above, the thermostatic hydrogel copolymer may include at least one phase change moiety copolymerized with at least one hydrogel moiety. In an embodiment, the phase change moiety may be derived from a phase change monomer comprising C₆ to C₅₀ methacrylic fatty acids, C₆ to C₅₀ acrylic fatty acids, C₆ to C₅₀ vinyl fatty acids, or combinations thereof, and the hydrogel moiety may be derived from a phase change hydrogel comprising acrylic acid, C₂-C₅₀ alkyl acrylates, C₂-C₅₀ alkyl methacrylates, C₂-C₅₀ alkyl-acrylamides, hydrophilic urethanes, or combinations thereof.

In an embodiment, the thermostatic hydrogel copolymer may be configured as at least a portion of a package insert for being disposed adjacent to the item, and the item may be packaged by disposing the package insert adjacent to the item, and enclosing the item and package insert within a packaging material. The package insert may be configured as a pad of fibers of the thermostatic hydrogel copolymer, and the fibers of the thermostatic hydrogel copolymer may be at least one of co-woven and blended with fibers of at least one additional polymer. The at least one additional polymer may be a polyester, polyethylene, polypropylen polypropylene polyethylene co-polymer, or any combinations thereof.

In an embodiment, the package insert may additionally include a biocidal agent configured for deterring growth of biological organisms within the packaging material, and the item may be packaged so that not only is temperature maintained adjacent the item, but also to at least reduce biological contamination adjacent the item. The item may be a food item that is susceptible to spoilage due to microbial growth, for example. The biocidal agent may include broad spectrum antibiotics, penicillin, sorbic acid, alkyl substituted quaternary ammonium compounds, aryl substituted quaternary ammonium compounds, chlorine containing compounds, iodine compounds, phenol, phenol derivatives, dehydroactic acid, peroxygen compounds, potassium persulfate, peracetic acid, sodium perborate, or combinations thereof.

Additives may be applied to the absorbent material in various ways. For example, the absorbent material may be wetted with an aqueous solution of the additive, followed by drying. Or, alternatively, the absorbent material may be mixed or impregnated with a dry agent. In general, any method of placing the additive within the absorbent material that will not adversely affect product quality may essentially be used to incorporate additive materials.

A thermostatic packaging material may be produced by covalently bonding at least one phase change material with a packaging material. The phase change material may include blocks of polymerized phase change material, and the blocks of polymerized phase change material may be grafted onto the packaging material.

In an embodiment, the packaging material may be a paper material (tissue, paper, cardboard) and the phase change material may be grafted to the paper. The phase change material may include at least one polymerizable moiety selected from acrylate, methacrylate, epoxy, vinyl, or combinations thereof. Acrylates and methacrylates may be selected from C₆ to C₅₀ alkyl acrylate, C₆ to C₅₀ alkyl methacrylate, or any combinations thereof.

In an alternative embodiment, the packaging material may be at least one polymer and the phase change material may be grafted to the polymer. The polymer may be cellulose, polyethylene, polypropylene, poly(ethylene-vinyl acetate), polystyrene, polyvinyl chloride, ionomer, polyethylene terephthalate, polyvinyl acetate, polycarbonates, polyamide, polyvinyl alcohol, polyvinylidene chloride, or any combinations thereof. The phase change material may include C₆ to C₅₀ alkyl acrylate, C₆ to C₅₀ alkyl methacrylate, or combinations thereof.

In a further embodiment, the packaging material may be at least one polymer and monomers of the phase change material may be copolymerized with at least one additional monomer to produce the at least one polymer. The at least one polymer may include cellulose, polyethylene, polypropylene, poly(ethylene-vinyl acetate), polystyrene, polyvinyl chloride, ionomer, polyethylene terephthalate, polyvinyl acetate, polycarbonates, polyamide, polyvinyl alcohol, polyvinylidene chloride, or any combinations thereof, and the phase change material may include C₆ to C₅₀ alkyl acrylate, C₆ to C₅₀ alkyl methacrylate, or any combinations thereof.

In an embodiment, the copolymerizing may include block polymerization. In a further embodiment, the copolymerizing may include copolymerizing monomers of the phase change material and hydrogel monomers. The monomers of the phase change material may be polymerized into blocks of phase change material, and the hydrogel monomers may be polymerized into blocks of hydrogel material, and the blocks of polymerized monomers of the phase change material and blocks of polymerized monomers of the hydrogel may be copolymerized by block polymerization to produce a block copolymer.

In an embodiment, the packaging material may include a packaging insert and producing the thermostatic packaging material may include producing fibers of the block copolymers, and forming the fibers into an absorbent pad to from the packaging insert. Producing the packaging material may include incorporating fibers of at least one additional polymer into the absorbent pad. The at least one additional polymer may include a polyester, polyethylene, polypropylene, polypropylene polyethylene co-polymer, or any combinations thereof. The production may also include incorporating at least one additional absorbent material into the absorbent pad. The at least one additional absorbent material may include tissue wraps, tissue laminates, sponge materials, foams, polymeric material, superabsorbent polymers, or any combinations thereof. Examples of additional absorbent materials and superabsorbent materials may include those as described above. The production may also include incorporating at least one additive into the absorbent pad. Examples of additives may include those as described above. The production may also include incorporating at least one biocidal agent into the absorbent pad. Examples of biocidal agents may include those as described above.

### EXAMPLES

### Example 1

### Thermostatic Packaging Material

Thermostatic food packaging containers having a thermal buffering temperature of about 0° C. to about 4° C. will be produced. The containers will be made from styrene, in the form or styrene blocks of 50-200 styrene units, co-polymerized with lauryl acrylate, in the form of blocks of 50-200 lauryl acrylate units, and will have a styrene to lauryl acrylate ratio of about 1/9 to about 9/1. The copolymer will be press-molded into bowl-shaped containers. The containers will be fitted with lids of the same material to isolate and thermally insulate any contents placed therein.

### Example 2

### Absorbent Thermostatic Package Inserts and Method for Producing

Absorbent thermostatic package inserts are made having a thermal buffering temperature of about 0° C. to about 5° C.

The inserts are made by co-polymerizing fatty acid monomers of vinyl laurate (melting point about 4° C.) with hydrogel monomers of (2-hydroxyethyl) methacrylate in the presence of EGDMA cross-linking agent. Vinyl laurate (10 mmol), (2-hydroxyethyl) methacrylate (10 mmol), EGDMA (10 mmol) and carbon tetrachloride (30 mL) are placed together into a 50 mL round-bottomed flask equipped with a reflux condenser under an argon atmosphere. The reactants are heated to about 50° C. for about 70 hours. The solvent is removed by vacuum and the final product is isolated by column chromatography.

The PCM-hydrogel copolymer will be processed into strands and woven into material layers. The layers will be stacked, cut into pads, and thermally sealed together at the edges to hold the layers together and form package inserts.

### Example 3

### Food Packaging with Absorbent Thermostatic Inserts

Packaging for raw beef steaks will by produced having a thermostatic buffering at temperatures of about 4° C. The packaging will include an expanded polystyrene tray having a bottom with extending bowl-shaped edges and a base size of, for example, about 20 cm by about 14 cm. Packaging inserts of Example 2 will be formed having a size of about 26 cm by about 20 cm to fit the bottom and sides of the of the tray. The insert layer will be placed as a liner in the bottom of the tray, and the beef steaks will be laid over the inserts. The entire package will be wrapped with low density polyethylene wrap to allow visibility of the product from the top. When stacked, most of the packages, with the exception of the top layer, will be surrounded on four sides with thermostatic material. During transport, an additional thermostatic layer may be provided for placement over the top of the packages. The packaged meat products will be held at about 2-3° C., and during transporting or short-term storage, as the ambient temperature rises to at or above about 4° C., the material will absorb heat from the ambient surroundings as the phase change material melts, thereby providing insulation to the food items. The liquefied phase change material will be retained within the absorbent insert, thereby eliminating free flowing liquids within the packaging.

### Example 4

### Thermal Cups for Retaining Heat

Thermostatic cups having a thermal buffering temperature of about 70° C. will be produced. The containers will be made from styrene, in the form or styrene blocks of 50-200 styrene units, co-polymerized with methacrylated stearic acid, in the form of blocks of 50-200 methacrylated stearic acid units, and will have a styrene to methacrylated stearic acid ratio of about 1/9 to about 9/1. The copolymer will be press-molded into cups and correspondingly fitting lids to isolate and thermally insulate hot beverages, such as coffee or tea, placed therein to maintain the beverages at a temperature of about 70° C.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A thermostatic packaging comprising:
a packaging material; and
at least one phase change material covalently bonded with the packaging material.

2. The thermostatic packaging of claim 1, wherein:
the phase change material comprises at least one block of polymerized phase change material; and
the at least one block of polymerized phase change material is grafted onto the packaging material.

3. The thermostatic packaging of claim 2, wherein the packaging material comprises at least one of a polymer and a paper.

4. The thermostatic packaging of claim 2, wherein the phase change material is derived from monomers of phase change material having a polymerizable moiety selected from acrylate, methacrylate, epoxy, vinyl, or any combination thereof.

5. The thermostatic packaging of claim 1, wherein:
the packaging material comprises cellulose, polyethylene, polypropylene, poly(ethylene-vinyl acetate), polystyrene, polyvinyl chloride, ionomer, polyethylene terephthalate, polyvinyl acetate, polycarbonates, polyamide, polyvinyl alcohol, polyvinylidene chloride, polyacrylate, polyurethane, protein, peptide, silk, lignocellulose, polyimide, epoxy resin or any combination thereof; and
the phase change material comprises C₆ to C₅₀ alkyl acrylate, C₆ to C₅₀ alkyl methacrylate, or any combination thereof.

6. The thermostatic packaging of claim 1, wherein the packaging material comprises a copolymer of monomers of the phase change material and at least one additional monomer.

7. The thermostatic packaging of claim 6, wherein the monomers of the phase change material comprise at least one polymerizable moiety selected from acrylate, methacrylate, epoxy, vinyl, or any combination thereof.

8. The thermostatic packaging of claim 6, wherein:
the monomers of the phase change material comprise C6 to C50 alkyl acrylate, C6 to C50 alkyl methacrylate, or any combination thereof; and
the at least one additional monomer comprises a monomer of cellulose, polyethylene, polypropylene, poly(ethylene-vinyl acetate), polystyrene, polyvinyl chloride, ionomer, polyethylene terephthalate, polyvinyl acetate, polycarbonate, polyamide, polyvinyl alcohol, polyvinylidene chloride, polyacrylate, polyurethane, protein, peptide, silk, lignocellulose, polyimide, epoxy resin, or any combination thereof.

9. The thermostatic packaging of claim 6, wherein the at least one additional monomer comprise a hydrogel.

10. The thermostatic packaging of claim 9, wherein the packaging material comprises a block copolymer of polymerized monomers of the phase change material and polymerized monomers of the hydrogel.

11. The thermostatic packaging of claim 10, wherein the monomers of the phase change material comprise a polymerizable moiety selected from acrylate, methacrylate, epoxy, vinyl, or any combination thereof.

12. The thermostatic packaging of claim 10, wherein:
the monomers of the phase change material comprise C6 to C50 methacrylic fatty acid, C6 to C50 acrylic fatty acid, C6 to C50 vinyl fatty acid, or any combination thereof; and
the monomers of the hydrogel comprise acrylic acid, C2-C50 alkyl acrylate, C2-C50 alkyl methacrylate, C2-C50 alkyl-acrylamide, hydrophilic urethane, or any combination thereof.

13. The thermostatic packaging of claim 1, wherein the packaging is configured for containing a food or drink item.

14. An absorbent packaging insert comprising at least one thermostatic hydrogel copolymer.

15. The insert of claim 14, wherein the thermostatic hydrogel copolymer comprises at least one phase change moiety copolymerized with at least one hydrogel moiety.

16. The insert of claim 14, wherein the phase change moiety is derived from a phase change monomer having a polymerizable functional group selected from acrylate, methacrylate, epoxy, vinyl, or any combination thereof.

17. The insert of claim 14, wherein:
the phase change moiety is derived from a phase change monomer comprising C6 to C50 methacrylic fatty acid, C6 to C50 acrylic fatty acid, C6 to C50 vinyl fatty acid, or any combination thereof; and
the hydrogel moiety is derived from a hydrogel monomer comprising acrylic acid, C2-C50 alkyl acrylate, C2-C50 alkyl methacrylate, C2-C50 alkyl-acrylamide, hydrophilic urethane, or any combination thereof.

18. The insert of claim 14, wherein the insert is a pad of fibers of the thermostatic hydrogel copolymer.

19. The insert of claim 18, wherein the fibers of the thermostatic hydrogel copolymer are at least one of co-woven with fibers of at least one additional polymer, and blended with fibers of at least one additional polymer, wherein the at least one additional monomer is selected from the group consisting of polyester, polyethylene, polypropylene, polypropylene polyethylene co-polymer, or any combination thereof.

20. The insert of claim 18, wherein the fibers of the thermostatic hydrogel copolymer are at least one of co-woven with at least one additional absorbent material, and blended with at least one additional absorbent material, wherein the at least one additional absorbent material is selected from the group consisting of tissue wrap, tissue laminate, sponge material, foam polymeric material, superabsorbent polymer, or any combination thereof.

21. The insert of claim 20, wherein the superabsorbent polymers comprise starch, cellulose, cellulosic material, poly(vinyl alcohol), poly(ethylene) oxide, cross-linked poly(acrylic acid), sodium salt of cross-linked poly(acrylic acid)/polyalcohol, sodium carboxy methyl cellulose cross-linked with an aluminum compound, superabsorbent composite of superabsorbent polymer granules adhered with at least one of binder and plasticizer, airlaid material incorporating at least one of superabsorbent fibrous structures and superabsorbent foam structure, nonwoven fabric structure that contain at least one of superabsorbent particles and superabsorbent fiber, absorbent structure containing superabsorbent material formed in-situ, absorbent structure containing superabsorbent material cross-linked in-situ, absorbent gelling material, or any combination thereof.

22. The insert of claim 20, further comprising at least one of:
at least one additive selected from binder fibers, bactericidal agents, clays, diatomaceous earth, inorganic salts, polymeric flocculating agents, carboxymethylcellulose, starch, dextrose, gelatin, xanthan gum, guar gum, and alginates, inorganic buffers, superabsorbent polymers in the form of in the form of a fiber, powder, flake, particle, granule, acrylic superabsorbent compounds, polypropylene/polyethylene binder fibers, polyester/polyethylene binder fibers, polyester/polypropylene fibers binder fibers, or combinations thereof; and
at least one biocidal agent selected from broad spectrum antibiotics, penicillin, sorbic acid, alkyl substituted quaternary ammonium compounds, aryl substituted quaternary ammonium compounds, chlorine containing compounds, iodine compounds, phenol, phenol derivatives, dehydroactic acid, peroxygen compounds, potassium persulfate, peracetic acid, sodium perborate, or combinations thereof.

23. The insert of claim 14, wherein the insert is an insert for a packaging configured for containing a food item.

24. A method for producing a thermostatic packaging material, the method comprising covalently bonding at least one phase change material with a packaging material.

25. The method of claim 24, wherein covalently bonding at least one phase change material comprises grafting blocks of polymerized phase change material onto the packaging material.

26. The method of claim 24, wherein covalently bonding at least one phase change material comprises grafting the phase change material to a paper.

27. The method of claim 24 wherein the phase change material comprises at least one polymerizable moiety selected from acrylate, methacrylate, epoxy, vinyl, or combinations thereof.

28. The method of claim 24, wherein the phase change material comprises C₆ to C₅₀ alkyl acrylate, C₆ to C₅₀ alkyl methacrylate, or combinations thereof.

29. The method of claim 24, wherein the method further comprises:
producing fibers of the block copolymers; and
forming the fibers into an absorbent pad.

30. The method of claim 29, further comprising at least one of:
incorporating fibers of at least one additional polymer into the absorbent pad;
incorporating at least one additional absorbent material into the absorbent pad;
incorporating at least one additive into the absorbent pad; and
incorporating at least one biocidal agent into the absorbent pad.

31. The method of claim 30, wherein:
the at least one additional polymer comprises polyesters, polyethylene, polypropylene, polypropylene polyethylene co-polymers, or combinations thereof;
the at least one additional absorbent material comprises at least one of tissue wraps, tissue laminates, sponge materials, foams, polymeric material, and superabsorbent polymers selected from the group consisting of starch, cellulose, cellulosic materials, poly(vinyl alcohol), poly(ethylene) oxide, cross-linked poly(acrylic acid), sodium salts of cross-linked poly(acrylic acid)/polyalcohol, sodium carboxy methyl cellulose cross-linked with an aluminum compound, superabsorbent composites of superabsorbent polymer granules adhered with at least one of binder and plasticizers, airlaid materials incorporating at least one of superabsorbent fibrous structures and superabsorbent foam structures, nonwoven fabric structures that contain at least one of superabsorbent particles and superabsorbent fibers, absorbent structures containing superabsorbent material formed in-situ, absorbent structures containing superabsorbent material cross-linked in-situ, absorbent gelling materials, or combinations thereof;
the at least one additive is selected from the group consisting of binder fibers, bactericidal agents, clays, diatomaceous earth, inorganic salts, polymeric flocculating agents, carboxymethylcellulose, starch, dextrose, gelatin, xanthan gum, guar gum, and alginates, inorganic buffers, superabsorbent polymers in the form of in the form of a fiber, powder, flake, particle, granule, acrylic superabsorbent compounds, polypropylene/polyethylene binder fibers, polyester/polyethylene binder fibers, polyester/polypropylene fibers binder fibers, or combinations thereof; and
the at least one biocidal agent comprises broad spectrum antibiotics, penicillin, sorbic acid, alkyl substituted quaternary ammonium compounds, aryl substituted quaternary ammonium compounds, chlorine containing compounds, iodine compounds, phenol, phenol derivatives, dehydroactic acid, peroxygen compounds, potassium persulfate, peracetic acid, sodium perborate, or combinations thereof.
